(19) United States
(12) Patent Application Publication
(10) Pub. No.: US 2020/0040663 A1
(43) Pub. Date: Feb. 6, 2020

(54) Electroformed thin-wall diamond drill bit with continuous wavy-shape blade

(71) Applicant: Qual Diamond Hi-Tech Corporation, San Diego, CA (US)

(72) Inventors: Qixing Fang, San Diego, CA (US); Youjun Sheng, San Diego, CA (US)

(21) Appl. No.: 16/053,322

(22) Filed: Aug. 2, 2018

(51) Int. Cl. E21B 10/60; E21B 10/46; B23B 51/04

(52) U.S. Cl. CPC E21B 10/60; E21B 10/46; B23B 51/0406; B23B 2200/0461; B23B 2226/18; B23B 2200/205; B23B 2226/31; B23B 2226/75; B23B 2226/45; B23B 2200/202

(57) ABSTRACT

A drill bit, formed of a a drill blank and a drill body. The drill body includes multiple outer projections and outer wall channels and multiple inner projections and inner wall channels, where the inner wall channels are formed as back sides of the outer projections and the inner wall channels have complementary shapes to the shapes of the outer projections, and the outer wall channels are formed as the backside of the inner projections, and the outer wall channels have complementary shapes to the shapes of the inner projections, where the outer projections and outer wall channels are distributed around a circumference of the drill body, and wherein each of the outer projections and outer wall channels include at least one curved parts therein.

### BACKGROUND

Diamond bit drills are known as drills that have very hard surfaces and hence can be used for a long period of time.

Currently, the diamond drill bits used to drill holes in glass, ceramic, stone and some other hard brittle inorganic non-metallic materials include single-layer electroplated diamond drill bits, sintered bronze diamond drill bits, and brazed diamond drill bits.

Single-layer electroplated diamond drill bit have a high sharpness; however, the single-layer coated diamond can shorten the life of the tool. Moreover, when the tool gets dull, the user needs to shut down the equipment and change the worn-out drill bit. This can happen frequently and repetitively, which increases downtime, labor intensity, and largely decreases production efficiency.

Sintered bronze diamond drill bits have a long service life, but due to the limitations of fabrication, they are not very sharp and have inconsistent quality, making them problematic for coolant drainage and chip removal. Dressing is also needed when the drill bit becomes dull which in turn leads to high labor intensity.

In a brazed diamond drill bit, diamond is brazed on to the tool base. Therefore, the diamond has a good adhesion to the base. This type of drill bit has good sharpness due to large amount of diamond grit protrusion, similar to an electroplated diamond drill bit. These also have a service lives which are longer than an electroplated diamond drill bit. However, since brazed diamond drill bit has only a single layer of diamond, its service life is much shorter than that of a sintered bronze diamond drill bit.

### SUMMARY

This invention was created to address the problems of different diamond drill bits that are popular in the market including low sharpness, short life, high labor intensity, chip clogging, and stuck drill bits.

The drill bit is formed of a drill blank and a drill blade connected as a one piece. The drill blade which is composed of diamond grits and electroforming metal fabricated by an electroforming technique. The drill blade is continuous, and the thickness of the wall of the drill blade is uniform. Projections and water channels are distributed on both the inner wall and the outer wall of the drill blade. The inner wall projection locations correspond to the outer wall water channel; The outer wall projection is the inner wall water channel location.

This invention is a drill bit tool for processing glass, ceramic, stone and some other hard brittle inorganic non-metallic materials. Specifically, embodiments describe a diamond drill bit with dimensions ranging from 1 to 150 mm.

The present invention describes a electroformed thin wall diamond bit drill bit. The drill bit is manufactured, as described herein, by using electroforming techniques that embed both diamond grits into an electroforming layer. In one embodiment, this is done to form a continuous wavy shape drill bit. The drill blade is formed of electroforming material mixed with diamond.

### BRIEF DESCRIPTION OF THE DRAWINGS

In the Drawings:

FIG. 1 shows an Embodiment of electroformed thin-wall diamond drill bit with a continuous wavy-shape blade;

FIG. 2 shows a top view of the drill bit;

FIG. 3 shows a drill blade partial enlargement;

FIG. 4 shows a 3D perspective view of the drill bit.

### DETAILED DESCRIPTION

Embodiments describe an electroformed thinwall diamond drill bit with a continuous wavy shape blade.

FIG. 1 shows an embodiment. This shows the drill blade having a thickness between 0.01 and 3 mm. The drill blade has a continuous cutting area at the front edge of the drill blade. The drill blade also has a uniform wall thickness around the edge of the blade. The outside of the blade also includes a diamond layer along the drill feed direction, where the diamond layer has a depth between 0.01 and 100 mm.

FIG. 1 shows a side view of the blade, showing the drill blank 1, and the drill blade 2, which is formed integrally to the drill blank 1 and continuous with the drill blade. The drill blade 2 is continuously formed, that is formed without segments. In an embodiment, the drill is intended to be a water or a wet drill. Projections and water channels are distributed on both the inner wall and the outer wall of the drill bit section 2. The drill is fed in the direction 100, and cuts in that direction also.

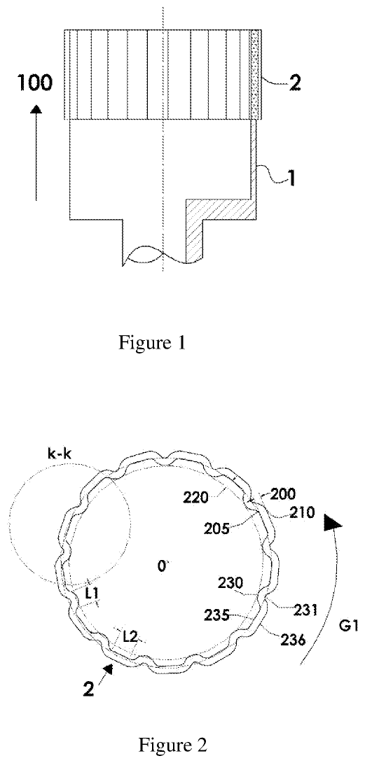

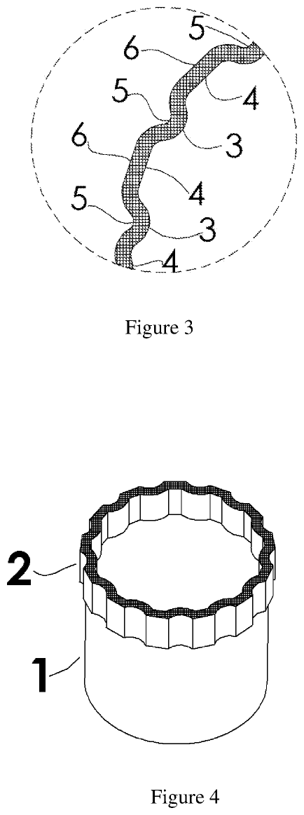

FIG. 2 shows a cross-section of the drill bit section 2 in the direction perpendicular to the feeding direction 100 of the drill bit, and FIG. 3 shows a close-up version of a section K-K of the drill bit section. There are multiple inner projections and outer projections. An inner projection 3 on the inner wall forms outer wall water channel 5 on the outer wall. In an analogous way, the projections on the outer wall such as 6 forms an inner wall channel for 4 the water channel on the inner wall.

In one embodiment, the inner wall projection 3 and the outer wall projection 6 are linearly distributed around the drill bit 2. That is, these projections are distributed with even spacing between each adjacent outer wall projection 6 and each adjacent inner wall projection 3.

In another embodiment, the projections are distributed helically with the same or opposite helical directions.

In an embodiment, each of the inner wall projection 3, inner wall water channel 4, outer wall water channel 5 and outer wall projection 6 have different shapes. The inner wall projection 3 has a shape 230, which is basically a rounded bump type shape. The inner wall water channel 4 has the shape 235, which is a shape with a flattened top, and two rounded sides, each of the rounded sides formed by a rounded edge of an adjacent inner wall projection 3. The outer wall channel 5 has the shape of an edge line shown as 231, that is the opposite shape from the projection 230 is formed as the outer wall channel, basically a rounded bump type concave shape. Similarly, the outer wall projection has the shape of 236, which is substantially flat on its top, and round edges, the mirror image of the section 235.

In an alternative embodiment, the projections can be combinations of or individuals of circular arcs, elliptical arcs, line segments, irregularly curved lines, or a combination of 2 or more of these.

FIG. 2 illustrates the wall thickness 200 of the drill blade 2 as being distance between the inner surface wall 205 and the outside surface wall 210. There are also, however, a number of channels that are shown in FIG. 2. The inner wall channel 220 has a depth that is defined as the radius difference between 2 concentric circles which would be centered at the work face center O; with the radius that is measured as the distance between O, and the point on the inner wall projection 3 that is nearest to the center O.

The second circle is again centered at the work face center O with a radius that is measured as the distance between O and the point on the inner wall cover channel for that is furthest from the center. That is, the distance between the sections 3 and 4 define this depth 220. In embodiments as described herein, the depth 220 is between 0.01 and 3 mm. The width of the inner wall projection 3 is greater than 0.01 mm. The width of the outer wall projection baseline is also greater than the same number 0.01 mm.

Both the inner wall projection 3 and the outer wall projection 6 includes one or more projection shapes. The inner wall projection includes complementary shapes to those outer shapes. The different shapes can be of different multiple sizes.

The inner and outer wall projections can be distributed either evenly or irregularly on the wall of the drill blade. Similarly, there are one or more water outlets throughout the inner and outer wall in the drill blade, and these can be distributed either evenly or irregularly over the surfaces of the walls.

The leveling effect of electroforming causes the outer wall projections 6 and the inner wall channel 5 to form a continuous cylindrical arc.

In an embodiment, the drill blade is intended to feed in the drill blade rotating direction G1.

The fabrication method of electroformed thin-wall diamond drill bit with continuous wavy-shape blade is explained herein:

Drill blank processing: steel blank, copper blank, stainless steel blank.

Temporary mold: plexiglass, low melting point alloys, electrically conductive non-metallics.

Diamond drill blade: connecting drill blank and temporary mold first; electroforming the piece together with diamond.

Remove the temporary mold.

Shape correction and dressing.

This invention has several major advantages because of its unique fabrication technique. The drill bit has a long service life due to the super high concentration of diamond grits that are enabled by the electroforming technique providing high wear resistance. The drill blade has high sharpness which improves the processing speed. The drill blade is a continuous ring without gaps, making the drilling stable with less chipping. The wall thickness is uniform along the drill blade. This prevents defects of thin wall part of water channel on the drill blade. The drill blade is strong and will not suffer fracture. The presence of projections on drill blade wall changes drilling mechanism from continuous grinding to partial impact grinding which improves processing speed. The projection part will be worn away gradually and it improves the self-sharpening effect of drill blade. No dressing is needed in the drilling process. The outer water channel is for water coming out; the inner water channel is for water coming in. This design provides good cooling down effect for the processing part and timely chip removal. It prevents drill blade burning and avoid the drill bit becoming stuck.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A drill bit, comprising:
a drill blank; and
a drill body,
where the drill body include multiple outer projections and outer wall channels and multiple inner projections and inner wall channels, where the inner wall channels are formed as back sides of the outer projections and the inner wall channels have complementary shapes to the shapes of the outer projections, and the outer wall channels are formed as the backside of the inner projections, and the outer wall channels have complementary shapes to the shapes of the inner projections, where the outer projections and outer wall channels are distributed around a circumference of the drill body, and wherein each of the outer projections and outer wall channels include at least one curved part therein, and where at least some of the shapes are different from one another.

2. The drill bit as in claim 1, wherein the outer projections and outer channels are linearly distributed around a circumference of the drill bit.

3. The drill bit as in claim 1, wherein one of the sets of wall channels forms a wall channel for water outlet, and the other wall channel provides a channel for water inlet.

4. The drill bit as in claim 1, wherein the drill body is formed by electroforming.

5. The drill bit as in claim 1, wherein the outer water channels are formed for water outlet and the inner wall channels are formed for water inlet.

6. The drill bit as in claim 1, wherein there are multiple different projection and channel shapes around the outside circumference of the drill, and no two adjacent shapes are the same shape.

7. The drill bit as in claim 6, wherein one of the projection shapes is a shape with rounded sides and a flattened top, and another of the projection shapes is a shape of a bump.

8. The drill bit as in claim 1, wherein the projection shapes are combinations of or individuals of circular arcs, elliptical arcs, line segments, and irregularly curved lines.

9. The drill bit as in claim 1, wherein the thickness of the drill bit is consistent around an entire circumference of the drill bit.

10. The drill bit as in claim 1, wherein the drill bit is continuous and not formed in separated parts.
